(19) United States
(12) Patent Application Publication
(10) Pub. No.: US 2009/0153640 A1
(43) Pub. Date: Jun. 18, 2009

(54) Thermal printer

(76) Inventors: Kimitaka Hirai, Chiba-shi (JP); Akihiko Ito, Chiba-shi (JP)

Correspondence Address: BRUCE L. ADAMS, ESQ;ADAMS & WILKS, SUITE 1231, 17 BATTERY PLACE, NEW YORK, NY, 10004, US

(21) Appl. No.: 12/315,633

(22) Filed: Dec. 4, 2008

(30) Foreign Application Priority Data
Dec. 14, 2007 (JP) 2007-323595

(51) Int. Cl. B41J 11/00

(52) U.S. Cl. 347/220

(57) ABSTRACT

In order to prevent a platen roller and shaft bearings from accidentally coming off from notches to improve reliability of a thermal printer, Provided is a thermal printer, including: a main body frame (2); a thermal head swingably mounted to the main body frame (2); a platen roller (6) which is disposed so as to be opposed to a printing surface of the thermal head and sandwiches thermal paper with the thermal head to feed the thermal paper; and a lock arm (5) which is swingably mounted to a supporting shaft (3) mounted to the main body frame (2) and presses shaft bearings (9) rotatably supporting the platen roller (6) to a thermal head side to lock the platen roller (6) with notches (10) formed in the main body frame (2), in which the lock arm (5) is provided, on the tip end portion thereof, with a first inclined surface (5d) which, when the platen roller (6) and the shaft bearings (9) are moved toward openings of the notches (10), comes into contact with the outer peripheral surface of each of the shaft bearings (9) and generates a force in a direction of opening the lock arm (5).

### BACKGROUND OF THE INVENTION

1. Field of the Invention

The present invention relates to a thermal printer.

2. Description of the Related Art

Conventionally, as a thermal printer, there is known a thermal printer disclosed in Patent Document 1, for example. In the thermal printer disclosed in Patent Document 1 (JP 2000-318260 A), shaft bearings for bearing-supporting a platen roller are sandwiched between notches formed on main body frame side walls and lock arms, whereby the platen roller is mounted to the main body frame.

However, in the thermal printer described in Patent Document 1, there arises a problem in that, when the thermal paper placed (set) between the thermal head and the platen roller is pulled by excessive force for cutting, whereby the platen roller and the shaft bearings are moved to the side opposite to the supporting shaft, the platen roller and the shaft bearings turn (are released) in the direction of opening the lock arm to come off from the notches, thereby making the printing impossible afterward.

### SUMMARY OF THE INVENTION

The present invention has been made in view of the above-mentioned problem, and it is an object of the present invention to provide a thermal printer capable of preventing a platen roller and shaft bearings from accidentally coming off from notches to thereby enable improvement in reliability.

The present invention employs the following means in order to solve the above-mentioned problem.

According to the present invention, there is provided a thermal printer including a main body frame, a thermal head swingably mounted to the main body frame, a platen roller which is disposed so as to be opposed to a printing surface of the thermal head and sandwiches thermal paper with the thermal head to feed the thermal paper, and a lock arm which is swingably mounted to a supporting shaft mounted to the main body frame and presses shaft bearings rotatably supporting the platen roller to a thermal head side to lock the platen roller with notches formed in the main body frame, in which the lock arm is provided, on a tip end portion thereof, with a first inclined surface which, when the platen roller and the shaft bearings are moved toward openings of the notches, comes into contact with an outer peripheral surface of each of the shaft bearings and generates a force in a direction of closing the lock arm.

According to the thermal printer of the present invention, even when the thermal paper placed (set) between the thermal head and the platen roller is pulled for cutting, whereby the platen roller and the shaft bearings are moved to the side opposite to the supporting shaft, the first inclined surface generates the force in the direction of closing the lock arm, and hence it is possible to prevent the platen roller and the shaft bearings from accidentally coming off from the notches (to prevent the platen roller from accidentally being released) to thereby enable improvement in reliability.

In the above-mentioned thermal printer, it is particularly preferable that the lock arm be provided, on the tip end portion thereof, with a second inclined surface which, when the platen roller and the shaft bearings are moved toward the openings of the notches, comes into contact with the outer peripheral surface of each of the shaft bearings and generates a force in a direction of opening the lock arm, and that the first inclined surface and the second inclined surface be formed so that the force in the direction of closing the lock arm is equal to or larger than the force in the direction of opening the lock arm.

In the thermal printer as described above, when the platen roller and the shaft bearings are moved toward the openings of the notches, the force in the direction of closing the lock arm is equal to or larger than the force in the direction of opening the lock arm. Therefore, it is possible to more reliably prevent the platen roller and the shaft bearings from accidentally coming off from the notches (more reliably prevent the platen roller from accidentally being released) to thereby enable further improvement in reliability.

The present invention has an effect of ensuring that the platen roller and the shaft bearings can be prevented from accidentally coming off from the notches to thereby enable improvement.

### BRIEF DESCRIPTION OF THE DRAWINGS

In the accompanying drawings:

FIG. 1 is a perspective view showing a thermal printer according to a first embodiment of the present invention;

FIG. 2 is a longitudinal sectional view showing a state in which a platen roller of the thermal printer of FIG. 1 is mounted thereto;

FIG. 3 is an enlarged view of a main portion of FIG. 2;

FIGS. 4A-4B are views showing a state in which the platen roller and shaft bearings are moved to a side opposite to a shaft, in which FIG. 4A is a view similar to FIG. 3, and FIG. 4B is a view further enlarging the main portion of FIG. 4A;

FIGS. 5A-5B are views showing a thermal printer according to a second embodiment of the present invention, in which FIG. 5A is a view similar to FIG. 4A, and FIG. 4B is a view further enlarging the main portion of FIG. 4A;

FIGS. 6A-6B are views showing the thermal printer according to the third embodiment of the present invention, in which FIG. 6A is a view similar to FIG. 4A, and FIG. 6B is a view further enlarging the main portion of FIG. 6A; and

FIG. 7 is a view showing a thermal printer according to another embodiment of the present invention, which is a longitudinal sectional view showing a state in which the platen roller is mounted thereto.

### DETAILED DESCRIPTION OF THE PREFERRED EMBODIMENT

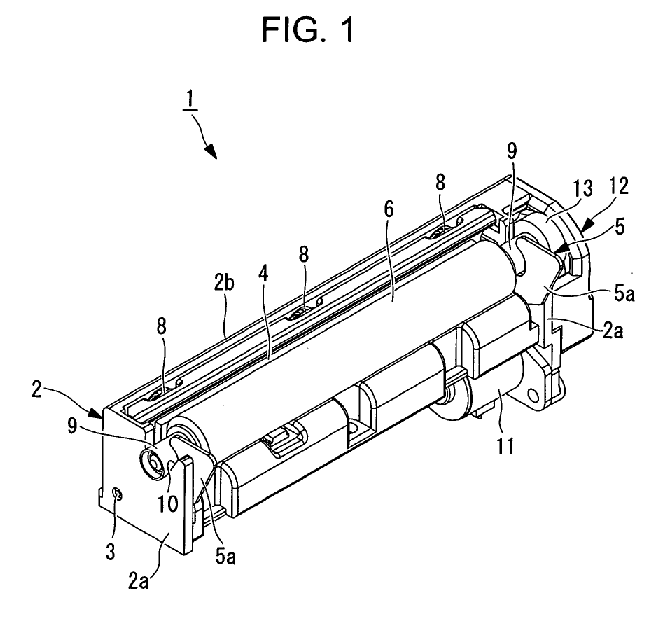

Hereinafter, the thermal printer according to the first embodiment of the present invention is described with reference to FIGS. 1 to 4A-4B.

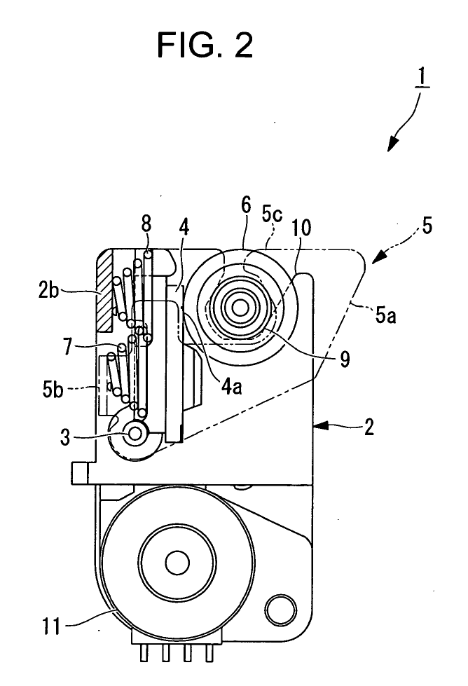

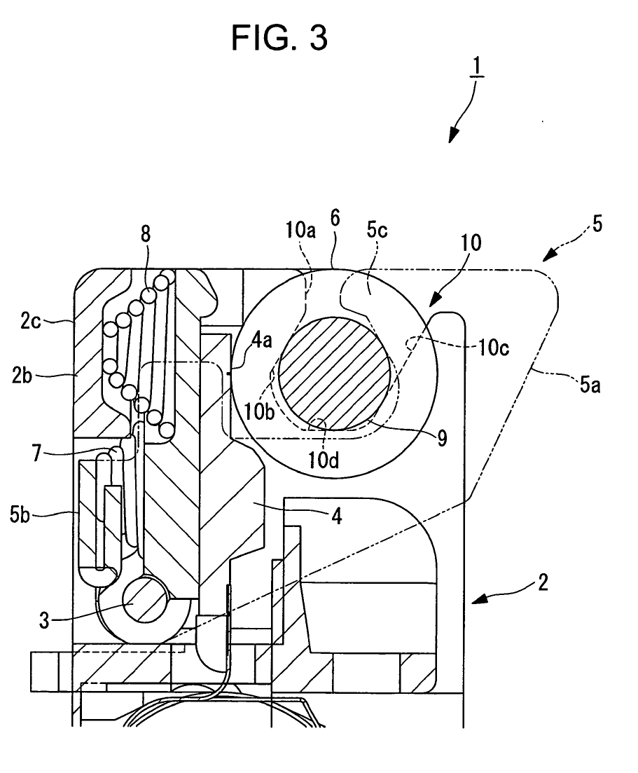

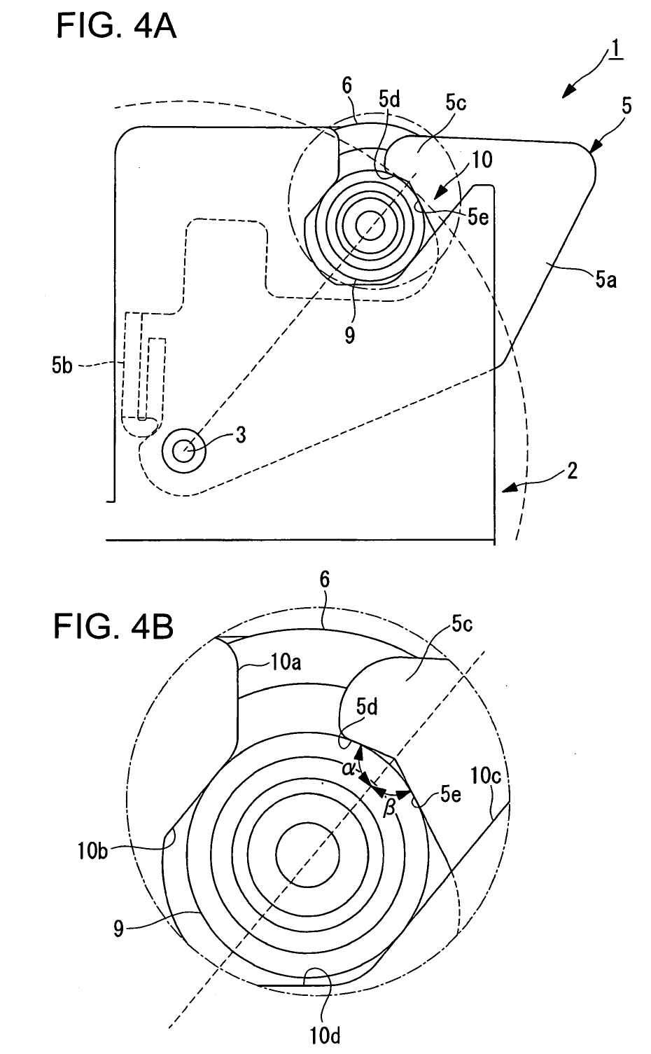

FIG. 1 is a perspective view showing a thermal printer according to this embodiment. FIG. 2 is a longitudinal sectional view showing a state in which a platen roller of the thermal printer of FIG. 1 is mounted. FIG. 3 is an enlarged view of a main portion of FIG. 2. FIGS. 4A-4B are views showing a state in which the platen roller and shaft bearings are moved to the side opposite to a shaft, in which FIG. 4A is a view similar to FIG. 3, and FIG. 4B is a view further enlarging the main portion of FIG. 4A.

As shown in FIG. 1, a thermal printer 1 of this embodiment includes: a main body frame 2; a thermal head 4 and a lock arm 5 swingably mounted to a coaxial shaft (supporting shaft) 3 of the main body frame 2; a platen roller 6 supported by the lock arm 5; first springs 7 (see FIG. 2) for biasing the platen roller 6 to the thermal head 4 side; and second springs 8 for biasing the thermal head 4 in the platen roller 6 direction.

The main body frame 2 is provided with side walls 2a bridged by the shaft 3 and a back surface coupling plate portion 2b for coupling the side walls 2a. The side walls 2a of the main body frame 2 are provided with notches 10, respectively, for receiving shaft bearings 9 (described later) of the platen roller 6. Further, the main body frame 2 is provided with a motor 11 and a rotation transmitting mechanism 12 for transmitting a rotational force of the motor 11 to the platen roller 6.

As shown in FIG. 2, the thermal head 4 is mounted to the shaft 3 mounted to the main body frame 2 so as to be capable of swinging about the shaft 3 in a state where a side surface, which is a back surface of a printing surface 4a provided on one surface side, is opposed to the back surface coupling plate portion 2b of the main body frame 2. The printing surface 4a of the thermal head 4 is disposed at a position where the printing surface 4a approximately corresponds to the back surface coupling plate portion 2b in a thickness direction of the thermal head 4.

Further, the second springs 8 are sandwiched between the back surface of the thermal head 4 and the back surface coupling plate portion 2b of the main body frame 2. Each second spring 8 is a compressed coil spring being a conical coil spring. Accordingly, the thermal head 4 is constantly biased in the printing surface 4a side due to a biasing force of the second springs 8.

The shaft bearings 9 for rotatably supporting the platen roller 6 are provided on both ends of the platen roller 6, respectively. Further, a gear 13, which engages with a gear 12a of the rotation transmitting mechanism 12 when the shaft bearings 9 are supported by the notches 10, is fixed to an end of the platen roller 6 (see FIG. 1).

The lock arm 5 is swingably mounted to the main body frame 2 by the shaft 3, and includes two side plate portions 5a extending along the both side walls 2a of the main body frame 2 and a back plate portion 5b for coupling the side plate portions 5a.

The lock arm 5 is provided with claw portions 5c at its end portions, which extend to the printing surface 4a side of the thermal head 4 in the state where the lock arm 5 is mounted to the main body frame 2, and prevent the platen roller 6 from being detached by enclosing the shaft bearings 9 of the platen roller 6 supported by the notches 10 of the main body frame 2 to decrease the opening widths of the notches 10. Further, in this state, the back plate portion 5b of the lock arm 5 is disposed to the back surface side of the thermal head 4.

In addition, as shown in FIG. 2, the first springs 7 are sandwiched between the back plate portion 5b of the lock arm 5 and the back surface of the thermal head 4. Each first spring 7 is a compressed coil spring being a conical coil spring.

Accordingly, the lock arm 5 is constantly biased by the first springs 7 in a direction of pressing the shaft bearings 9 of the platen roller 6 against the notches 10 of the main body frame 2. Further, in the state where the shaft bearings 9 of the platen roller 6 are pressed against the notches 10, the claw portions 5c decrease the opening widths of the notches 10 and the shaft bearings 9 are supported so as not to be detached from the notches 10, and hence platen roller 6 is locked in a positioning state with respect to the main body frame 2.

Note that in this embodiment, the back plate portion 5b of the lock arm 5 is disposed closer to the side of the shaft 3, serving as a swing center of the lock arm 5, than the back surface coupling plate portion 2b of the main body frame 2 is. Accordingly, the first springs 7 sandwiched between the back plate portion 5b and the back surface of the thermal head 4 are disposed closer to the swing center than the second springs 8 sandwiched between the back surface coupling plate portion 2b and the back surface of the thermal head 4 are.

In the thermal printer 1 according to this embodiment, the notches 10 and the claw portions 5c have a plan view shape (outline) as shown in FIG. 3.

Specifically, the notches 10 each include a parallel surface 10a which is formed so as to be apart from the back surface coupling plate portion 2b by a predetermined distance and to be parallel (or substantially parallel) to the back surface 2c of the back surface coupling plate portion 2b, a first inclined surface 10b which is inclined with respect to the parallel surface 10a and extends from an end edge (lower edge) of the parallel surface 10a to the shaft 3 side, a second inclined surface 10c which is formed so as to be parallel (or substantially parallel) to the first inclined surface 10b, and a bottom surface 10d which is coupled to an end edge (lower edge) of the first inclined surface 10b and an end edge (lower edge) of the second inclined surface 10c. Further, a space formed by the first inclined surface 10b, the second inclined surface 10c, and the bottom surface 10d is formed so as to be capable of receiving (containing) the shaft bearings 9 of the platen roller 6.

Further, as shown in FIG. 4A and FIG. 4B, the claw portions 5c each include a third inclined surface (first inclined surface) 5d and a fourth inclined surface (second inclined surface) 5e which come into contact, when the platen roller 6 and the shaft bearings 9 are moved to the side opposite to the shaft 3 side, with an outer peripheral surface of each of the shaft bearings 9 placed on the side opposite to the shaft 3.

The third inclined surface 5d is a flat surface which generates, in the case where the platen roller 6 and the shaft bearings 9 are moved to the side opposite to the shaft 3 and the outer peripheral surface of each of the shaft bearings 9 comes into contact with the third inclined surface 5d, the force on the lock arm 5 in the direction of closing the lock arm 5 (counterclockwise direction in FIG. 4A). Further, the fourth inclined surface 5e is a flat surface which generates, in the case where the platen roller 6 and the shaft bearings 9 are moved to the side opposite to the shaft 3 and the outer peripheral surface of each of the shaft bearings 9 comes into contact with the fourth inclined surface 5e, the force on the lock arm 5 in the direction of opening the lock arm 5 (clockwise direction in FIG. 4A).

Note that an angle a formed between the third inclined surface 5d and a straight line extending from the center of the shaft, an angle β formed between the fourth inclined surface 5e and the straight line extending from the center of the shaft, the length of the third inclined surface 5d (that is, the length from a contact point (border) between the third inclined surface 5d and the fourth inclined surface to a contact point between the third inclined surface 5d and the outer peripheral surface of each of the shaft bearings 9), and the length of the fourth inclined surface 5e (that is, the length from the contact point (border) between the third inclined surface 5d and the fourth inclined surface to a contact point between the fourth inclined surface 5e and the outer peripheral surface of each of the shaft bearings 9) are set to be such angles and lengths that the platen roller 6 and the shaft bearings 9 do not come off from the notches 10 even when the platen roller 6 and the shaft bearings 9 are moved to the side opposite to the shaft 3. For example, when the angle α formed between the third inclined surface 5d and the straight line extending from the center of the shaft is smaller than the angle β formed between the fourth inclined surface 5e and the straight line extending from the center of the shaft, the force by which the lock arm 5 is closed becomes larger than the force by which the lock arm 5 is opened. Further, when the angle α formed between the third inclined surface 5d and the straight line extending from the center of the shaft is equal to the angle β formed between the fourth inclined surface 5e and the straight line extending from the center of the shaft, the force by which the lock arm 5 is closed becomes equal to the force by which the lock arm 5 is opened.

An operation of the thermal printer 1 of this embodiment structured as described above is described below.

According to the thermal printer 1 of this embodiment, in performing printing while sandwiching thermal paper (not shown) between the thermal head 4 and the platen roller 6, first, the thermal paper is disposed on the printing surface 4a of the thermal head 4. Then, an external force is applied to the lock arm 5 to swing the lock arm 5 in a direction of moving the claw portions 5c away from the thermal head 4 to increase opening widths of the notches 10 provided to the side walls 2a of the main body frame 2.

In this case, the first springs 7 disposed between the back plate portion 5b of the lock arm 5 and the back surface of the thermal head 4 are compressed, and hence the lock arm 5 is swung against a biasing force of the first springs 7. In order to satisfactorily increase the opening width of each notch 10 of each side wall 2a of the main body frame 2, the claw portions 5c of the lock arm 5 should be satisfactorily swung. Accordingly, the first springs 7 are compressed.

In this embodiment, the first springs 7 are disposed closer to the shaft 3, serving as the swing center of the lock arm 5, than the claw portions 5c of the lock arm 5 are. Therefore, the first springs 7 having a stroke satisfactorily smaller than a displacement amount of the claw portions 5c can be used. As a result, a provision space of the first springs 7 disposed on the back surface side of the thermal head 4 can be made smaller.

As the first springs 7, conical coil springs are used. Thus, it is possible to reduce solid height thereof, and the provision space thereof can be made further smaller.

Further, in a state where the platen roller 6 is not mounted, the thermal head 4 is biased to the printing surface 4a side by the second springs 8 to swing about the shaft 3. In a case where the lock arm 5 is swung in a direction of increasing the opening widths of the notches 10, the platen roller 6 is detached from the notches 10. Thus, the thermal head 4 swings to the printing surface 4a side, thereby reducing the stroke of the first springs 7.

Then, the shaft bearings 9 of the both ends of the platen roller 6 are inserted into the notches 10 having the increased opening widths, whereby the notches 10 support the shaft bearings 9. In this state, the external force applied to the lock arm 5 is released. Accordingly, the lock arm 5 biases the platen roller 6 in a direction so that the platen roller 6 comes closer to the thermal head 4 and presses each of the shaft bearings 9 against the first inclined surface 10b, the second inclined surface 10c, and the bottom surface 10d of each of the notches 10 of the main body frame 2, the claw portions 5c move in a direction of decreasing the opening widths of the notches 10, and the shaft bearings 9 of the platen roller 6 are supported by the claw portions 5c so as not to be detached from the notches 10. Accordingly, the platen roller 6 is locked in a positioning state with respect to the main body frame 2.

In this embodiment, the thermal head 4 is biased to the printing surface 4a side by the second springs 8. Thus, at a position in the midst of the lock operation by the lock arm 5, the platen roller 6 sandwiches the thermal paper with the printing surface 4a of the thermal head 4. When the lock operation by the lock arm 5 completes, the platen roller 6 presses the thermal head 4 to sandwich the thermal paper, thereby compressing the second springs 8.

In this case, the shaft bearings 9 of the platen roller 6 are each pressed against the first inclined surface 10b, the second inclined surface 10c, and the bottom surface 10d of each of the notches 10, whereby the platen roller 6 is positioned. In addition, the position of the back surface coupling plate portion 2b for supporting the second springs 8 is fixed. Therefore, when the platen roller 6 is locked by the lock arm 5, the second springs 8 are always compressed by a specific length. Accordingly, the thermal paper is always sandwiched between the thermal head 4 and the platen roller 6 by a specific pressurizing force with the result that stable printing can be performed without fluctuating printing conditions. Then, the platen roller 6 is rotated by the operation of the motor 11 via the rotation transmitting mechanism 12 to feed the thermal paper, whereby printing is performed by the thermal head 4.

Further, the second springs 8 are disposed so as to be opposed to a contact position of the platen roller 6 and the printing surface 4a of the thermal head 4 with an intermediation of the thermal head 4, and apply a biasing force along an extended line connecting the contact position and a center position of the platen roller 6. Thus, the biasing force which is generated by the second springs 8 can be efficiently used as a pressurizing force of the printing surface 4a with respect to the thermal paper to minimize dimensions of the second springs 8.

Further, in this embodiment, the second springs 8 for pressing the thermal head 4 are not used to return the lock arm 5 to its original state, and hence each second spring 8 does not need large stroke. Therefore, it is possible to reduce the stroke to make the provision space smaller.

According to the thermal printer 1 of the present invention, even when, for example, thermal paper placed (set) between the thermal head 4 and the platen roller 6 is pulled for cutting, whereby the platen roller 6 and the shaft bearings 9 are moved to the side opposite to the shaft 3, a force in the direction of closing the lock arm 5 is generated due to the third inclined surface 5d, and hence it is possible to prevent the platen roller and the shaft bearings 9 from accidentally coming off from the notches 10 (to prevent the platen roller 6 from accidentally being released) to thereby enable improvement in reliability.

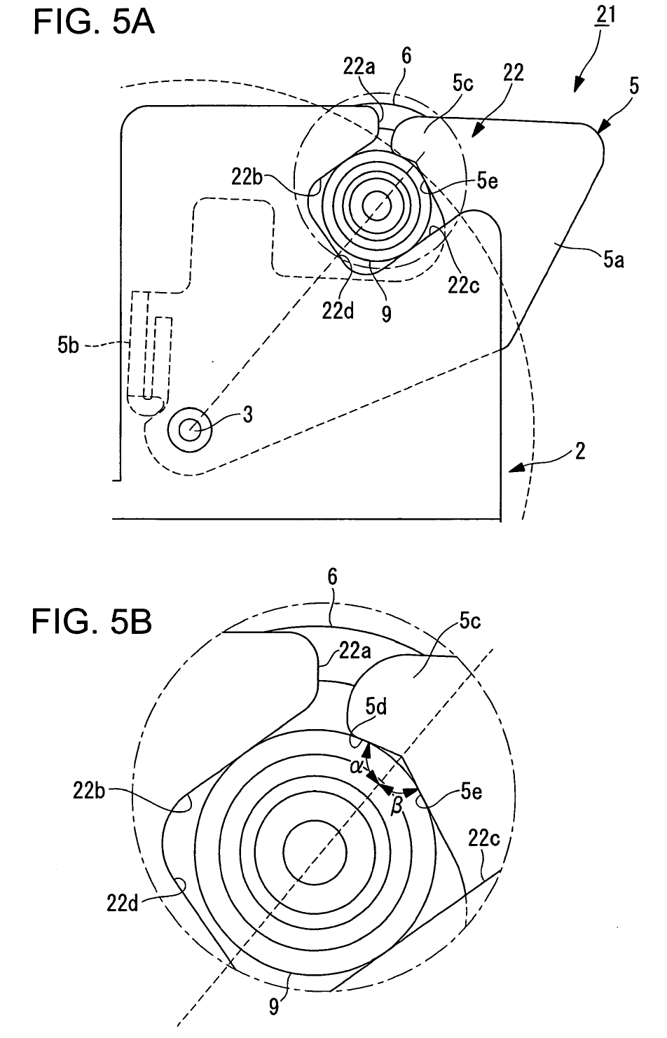

A thermal printer according to a second embodiment of the present invention is described with reference to FIGS. 5A-5B.

FIGS. 5A-5B are views showing the thermal printer according to this embodiment, in which FIG. 5A is a view similar to FIG. 4A, and FIG. 5B is a view further enlarging the main portion of FIG. 5A.

As shown in FIGS. 5A-5B, a thermal printer 21 according to this embodiment is different from the above-mentioned thermal printer according to the first embodiment in that notches 22 are provided instead of the notches 10. Other components are the same as those of the above-mentioned first embodiment, and hence the descriptions thereof are omitted here.

The notches 22 each include a parallel surface 22a which is formed so as to be apart from the back surface coupling plate portion 2b (see FIG. 2 and FIG. 3) by a predetermined distance and to be parallel (or substantially parallel) to the back surface 2c (see FIG. 3) of the back surface coupling plate portion 2b, a first inclined surface 22b which is inclined with respect to the parallel surface 22a and extends from an end edge (lower edge) of the parallel surface 22a to the shaft 3 side, a second inclined surface 22c which is formed so as to be parallel (or substantially parallel) to the first inclined surface 22b, and a bottom surface 22d which couples an end edge (lower edge) of the first inclined surface 22b and an end edge (lower edge) of the second inclined surface 22c. Further, a space formed by the first inclined surface 22b, the second inclined surface 22c, and the bottom surface 22d is formed so as to be capable of receiving (containing) the shaft bearings 9 of the platen roller 6.

Note that the first inclined surface 22b and the second inclined surface 22c according to this embodiment are formed so that angles formed between each of the first inclined surface 22b and the second inclined surface 22c, and the back surface 2c of the back surface coupling plate portion 2b are larger than angles formed between each of the first inclined surface 10b and the second inclined surface 10c of the first embodiment, and the back surface 2c of the back surface coupling plate portion 2b, respectively. That is, the first inclined surface 22b and the second inclined surface 22c of this embodiment are formed so that the openings of the notches 22 face the front side (opposite side with respect to the back surface 2c of the back surface coupling plate portion 2b) compared with the openings of the notches 10.

The effect of the thermal printer 21 according to this embodiment is the same as that of the above-mentioned first embodiment, and hence the description thereof is omitted.

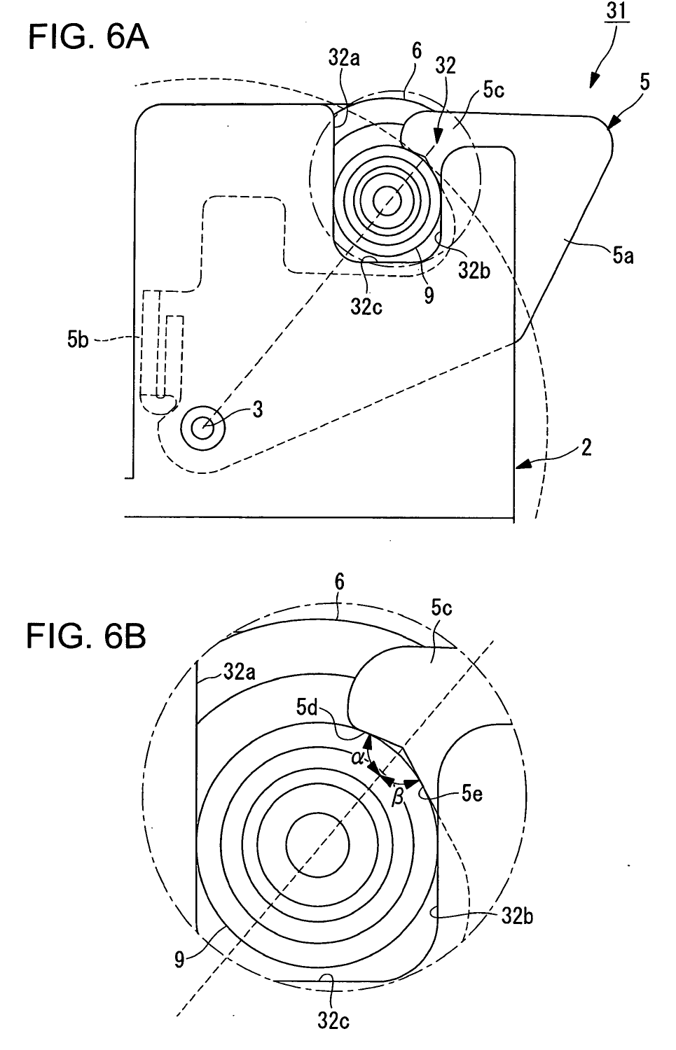

A thermal printer according to a third embodiment of the present invention is described with reference to FIGS. 6A-6B.

FIGS. 6A-6B are views showing the thermal printer according to this embodiment, in which FIG. 6A is a view similar to FIG. 4A, and FIG. 6B is a view further enlarging the main portion of FIG. 6A.

As shown in FIGS. 6A-6B, a thermal printer 31 according to this embodiment is different from the above-mentioned thermal printer according to the first embodiment in that notches 32 are provided instead of the notches 10. Other components are the same as those of the above-mentioned first embodiment, and hence the descriptions thereof are omitted here.

The notches 32 each include a first parallel surface 32a which is formed so as to be apart form the back surface coupling plate portion 2b (see FIG. 2 and FIG. 3) by a predetermined distance and to be parallel (or substantially parallel) to the back surface 2c (see FIG. 3) of the back surface coupling plate portion 2b, a second parallel surface 32b which is formed so as to be parallel (or substantially parallel) to the first parallel surface 32a, and a bottom surface 32c which couples an end edge (lower edge) of the first parallel surface 32a and an end edge (lower edge) of the second parallel surface 32b. Further, a space formed by the first parallel surface 32a, the second parallel surface 32b, and the bottom surface 32c is formed so as to be capable of receiving (containing) the shaft bearings 9 of the platen roller 6.

The effect of the thermal printer 31 according to this embodiment is the same as that of the above-mentioned first embodiment, and hence the description thereof is omitted.

Note that the present invention is not limited to the above-mentioned embodiments, and can be varied, modified, or combined arbitrarily as needed without departing from the technical idea of the present invention.

Further, in the embodiments described above, the third inclined surface 5d and the fourth inclined surface 5e are directly connected to each other. However, the present invention is not limited thereto, and hence the third inclined surface 5d and the fourth inclined surface 5e may be connected through the intermediation of a fifth inclined surface (planer surface or curved surface) (not shown) and the like.

In this case, when the angle α formed between the third inclined surface 5d and the straight line extending from the center of the shaft is equal to or smaller than the angle β formed between the fourth inclined surface 5e and the straight line extending from the center of the shaft, and the length of the third inclined surface 5d (that is, the length from the contact point (border) between the third inclined surface 5d and the fourth inclined surface 5e to the contact point between the third inclined surface 5d and the outer peripheral surface of the shaft bearing 9) is longer than the length of the fourth inclined surface 5e (that is, the length from the contact point (border) between the third inclined surface 5d and the fourth inclined surface 5e to the contact point between the fourth inclined surface 5e and the outer peripheral surface of the shaft bearing 9), a force by which the lock arm 5 is closed becomes larger than a force by which the lock arm 5 is opened. Further, when the angle α formed between the third inclined surface 5d and the straight line extending from the center of the shaft is equal to the angle β formed between the fourth inclined surface 5e and the straight line extending from the center of the shaft, and the length of the third inclined surface 5d is equal to the length of the fourth inclined surface 5e, the force by which the lock arm 5 is closed becomes equal to the force by which the lock arm 5 is opened.

Further, the notches 10, 22, 32 of the embodiments described above are formed so that the first inclined surface 10b, 22b and the second inclined surface 10c, 22c become parallel (or substantially parallel) to each other, and formed so that the first parallel surface 32a and the second parallel surface 32b become parallel (or substantially parallel) to each other. However, the present invention is not limited thereto, and hence the opening width may be increased toward the opening direction.

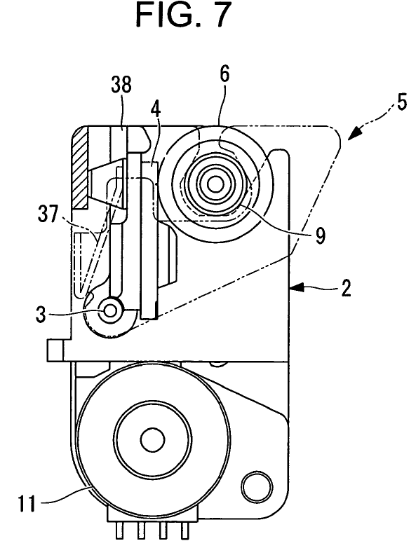

Further, in the thermal printer 1, 21, and 31 according to this embodiment described above, conical coil springs are employed as the first springs 7 and the second springs 8. Alternatively, as shown in FIG. 7, plate springs 37 and 38 may be employed.

As shown in FIG. 7, a first spring 37 for biasing the lock arm 5 and a second spring 38 for pressing the thermal head 4 are constituted by different plate springs.

The first spring 37 is constituted by extending a portion of the back plate portion 5b constituting the lock arm 5. Another end of the first spring 37 is extended to a back surface side of the second spring 38, whereby the biasing force for biasing the thermal head 4 with respect to the platen roller 6 can be increased.

Further, by separately providing the first spring 37 and the second spring 38, as described above, the provision space in the back surface side of the thermal head 4 can be made smaller to make it compact. In particular, by employing the plate springs, even in the smaller provision space, a relatively large biasing force can be exerted to perform stable printing.

What is claimed is:

1. A thermal printer, comprising:
a main body frame;
a thermal head swingably mounted to the main body frame;
a platen roller which is disposed so as to be opposed to a printing surface of the thermal head and sandwiches thermal paper with the thermal head to feed the thermal paper; and
a lock arm swingably mounted to a supporting shaft mounted to the main body frame and presses shaft bearings rotatably supporting the platen roller to a thermal head side to lock the platen roller with notches formed in the main body frame,
wherein the lock arm is provided, on a tip end portion thereof, with a first inclined surface which, when the platen roller and the shaft bearings are moved toward openings of the notches, comes into contact with an outer peripheral surface of each of the shaft bearings and generates a force in a direction of closing the lock arm.

2. A thermal printer according to claim 1,
wherein the lock arm is provided, on the tip end portion thereof, with a second inclined surface which, when the platen roller and the shaft bearings are moved toward the openings of the notches, comes into contact with the outer peripheral surface of each of the shaft bearings and generates a force in a direction of opening the lock arm, and
wherein the first inclined surface and the second inclined surface are formed so that the force in the direction of closing the lock arm is closed is equal to or larger than the force in the direction of opening the lock arm.
